(19) United States
(12) Patent Application Publication
(10) Pub. No.: US 2010/0012282 A1
(43) Pub. Date: Jan. 21, 2010

(54) Velocity reduction system for retractable screen doors

(76) Inventor: Robert C. Franklin, Los Gatos, CA (US)

Correspondence Address: Robert Charles Hill, 235 Montgomery Street # 821, San Francisco, CA, 94104, US

(21) Appl. No.: 12/218,941

(22) Filed: Jul. 18, 2008

(51) Int. Cl. E06B 9/00

(52) U.S. Cl. 160/371

(57) ABSTRACT

A velocity reduction system for use in retractable screen door installations. A pneumatic cylinder is located within a moveable housing that is used to capture the leading edge of the screen material. The pneumatic cylinder contains a moveable weight that is fastened to the screen doorframe using a cable. Incorporated within the weight is a check valve that restricts the passage of air when the weight is being pulled in an upward direction, associated with the opening of the screen door. The size of an aperture at the lower end of the pneumatic cylinder, along with the strength of the retracting spring that rewinds the screen material, control the velocity of air entering the pneumatic cylinder and therefore the opening speed of the screen door.

### FIELD OF INVENTION

This invention relates to a velocity reduction system that can be incorporated in a retractable, spring-loaded screen door mechanism in order to prevent the door from moving too rapidly in a motion that might cause physical damage to the mechanism, adjacent property, or cause personal injury. Retractable screen doors have become a desirable alternative to the standard, hinged screen doors in that they can be retracted from a closed condition, in which they prohibit the entry of insects or other pests, to an open condition in which the screen will become stored in an associated enclosure. The typical retractable screen mechanism involves a spring-loaded spool located within an associated enclosure and upon which the screen or other flexible material is wound. The leading edge of the screen material is the vertical edge, external to the associated enclosure, and is attached to a moveable housing. This moveable housing is captured at the top and bottom, along with the top and bottom edges of the screen, in upper and lower tracks. A latching mechanism, typically incorporating a magnet, is used to hold the screen in a closed position.

### DESCRIPTION OF PRIOR ART

There are two basic approaches described in prior art that are designed to reduce the velocity of spring-loaded screen doors. One approach incorporates the use of a viscous fluid that retards the movement of one or more impeller blades. This approach is described, for example, in the U.S. Pat. No. 6,591,890 issued to Grubb et al, dated Jul. 15, 2003. The second approach of velocity reduction involves the use of a centrifugal braking apparatus that spins small brake shoes or the like against an adjacent surface as the screen is retracted, thus producing a frictional braking effect. This approach is described, along with a fluid braking system, in U.S. Pat. No. 6,155,328 issued to Welfonder, and dated Dec. 5, 2000. While these approaches of velocity reduction are used in existing applications they suffer from four known deficiencies. First, in the case of friction braking, there is a tendency to become less effective as the friction surface becomes worn smooth and therefore can require replacement of the complete braking assembly. Second, in the case of the viscous fluid systems, there have been reported occasions in which the fluid has leaked past the seal elements and dripped onto a nearby floor or other surface. The third deficiency is common to both of the above approaches of velocity reduction. Because the retarding mechanisms are located within the same enclosure as the retracting spring, a condition can occur in which an individual opening the screen door can force the screen to open faster than the velocity reduction system will allow. This causes the screen to bunch or blouse as referred to in the trade. Such blousing can cause the top and bottom edges of the screen to exit the upper and lower guides or tracks, often resulting in damage to the edges of the screen material which can become jammed in the retraction mechanism. Lastly, the retraction mechanisms typically have no means of easily adjusting the retraction speed. As will be seen in the following description the present invention overcomes all of the above deficiencies.

### SUMMARY OF THE INVENTION

This invention provides a velocity reduction system for screen doors by utilizing a pneumatic cylinder located in the movable housing that is used to capture the external, leading edge of the screen. The pneumatic cylinder contains a movable weight that is connected by a cable to the fixed portion of the screen door frame or screen retaining track. Housed within the movable weight is a check valve apparatus that restricts the passage of air when the weight is being pulled in an upward direction, associated with the opening of the screen door. The rate at which air is allowed to enter the cylinder volume below the check valve is established by a defined aperture connected to the bottom outlet of the pneumatic cylinder. This creates a pressure differential that retards the movement of the screen in an opening direction. When the weight is allowed to fall in a vertical direction, associated with the closing of the screen door, the check valve opens, allowing the free passage of air through the check valve. With the present invention the size of the defined aperture can be physically changed by replacing a metering insert in order to vary the rate at which air can enter the volume below the check valve. This, in turn, will control the rate of movement of the screen door as it moves in an opening direction. Also, by providing a replaceable metering insert, compensation can be made for the variations in atmospheric pressure as might be encountered in sea level versus mountain locations, since this would affect the rate of air flow passing through the metering insert.

### DESCRIPTION OF THE DRAWINGS

FIG. 1 is a front view of a typical retractable screen door installation.

FIG. 2 is a front cutaway view of the location of the velocity reduction system used in typical prior art retractable screen door systems.

FIG. 3 is a front cutaway view of the pneumatic velocity reduction system located in the moveable housing and described in the present invention.

FIG. 3A is a side view of the top portion of the screen door track system.

FIG. 4 is an enlarged cross sectional view of the check valve apparatus used in the present invention as it is moving in an upward direction.

FIG. 5 is an enlarged cross sectional view of the check valve apparatus used in the present invention as it is moving in a downward direction.

### DETAILED DESCRIPTION OF INVENTION

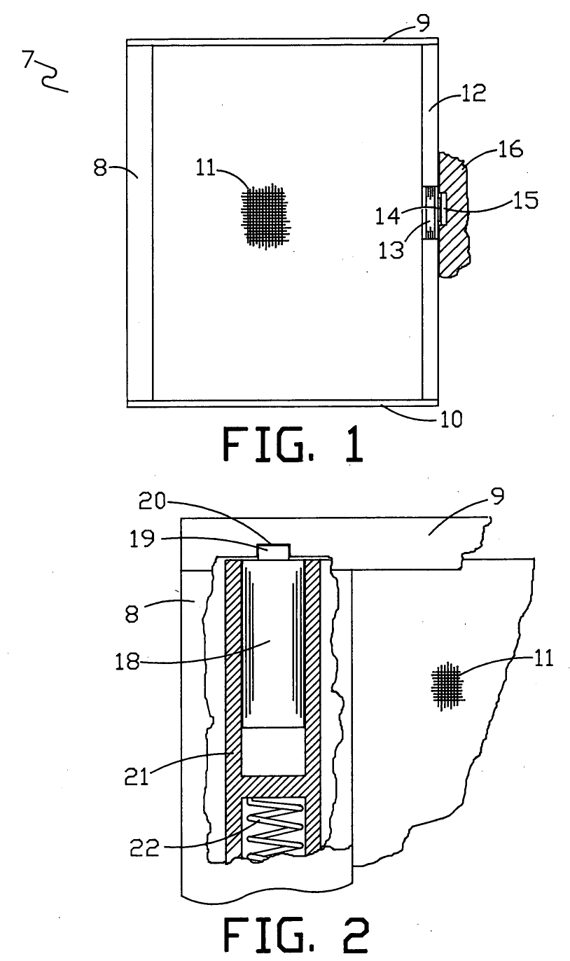

FIG. 1 shows the configuration of a retractable screen door installation 7 as it is presently installed using existing designs. The enclosure 8 houses the retraction spring and velocity reduction assembly to be described later. Screen material 11 occupies the space between the enclosure 8 and the moveable housing 12 and provides the means to prevent intrusion by insects, pests or debris that might be blown in by the wind. Tracks 9 and 10 provide the upper and lower guides respectively for the screen 11 material and the upper and lower portions of the moveable housing 12. Handle 13 represents an exterior handle and provides a means for an individual to open and close the screen door. A second handle, not shown, is located in the same vertical position as the exterior handle but is located on the interior surface of the moveable housing 12. Ferromagnetic piece 14 is attached to the outer edge of the moveable housing 12 and serves as a holding contact for magnet 15. Magnet 15 is attached to the doorframe 16. The magnet 15 strength is of a magnitude sufficient to hold the screen in a closed position as shown. When an individual wishes to open the screen door, a sufficient force is required to overcome this magnetic attraction. Once the magnetic force is overcome, the retraction spring, to be shown later, will cause the screen 11 to be pulled to the left and spooled into enclosure 8. The moveable housing 12 will also move leftward until is reaches the stop limit when it contacts the enclosure 8.

FIG. 2 shows a cutaway view of the upper left corner of the standard screen door installation shown in FIG. 1. The velocity reduction assembly 18 is located within enclosure 8, along with the screen spool 21 and coil spring 22. Velocity reduction assembly 18 has a press fit connection within screen spool 21 and rotates axially in conjunction with the screen spool 21. Rotor 19 rotates within the velocity reduction assembly 18 and is fixed relative to the track 9 at point 20. Coil spring 22 exerts the rotational force necessary to wind the screen material 11 on the spool 21. This brief explanation of existing velocity reduction systems is provided to clarify the difference between existing systems and the system described in this invention. Further explanation of the velocity reduction assemblies presently in use can be found in the prior art references.

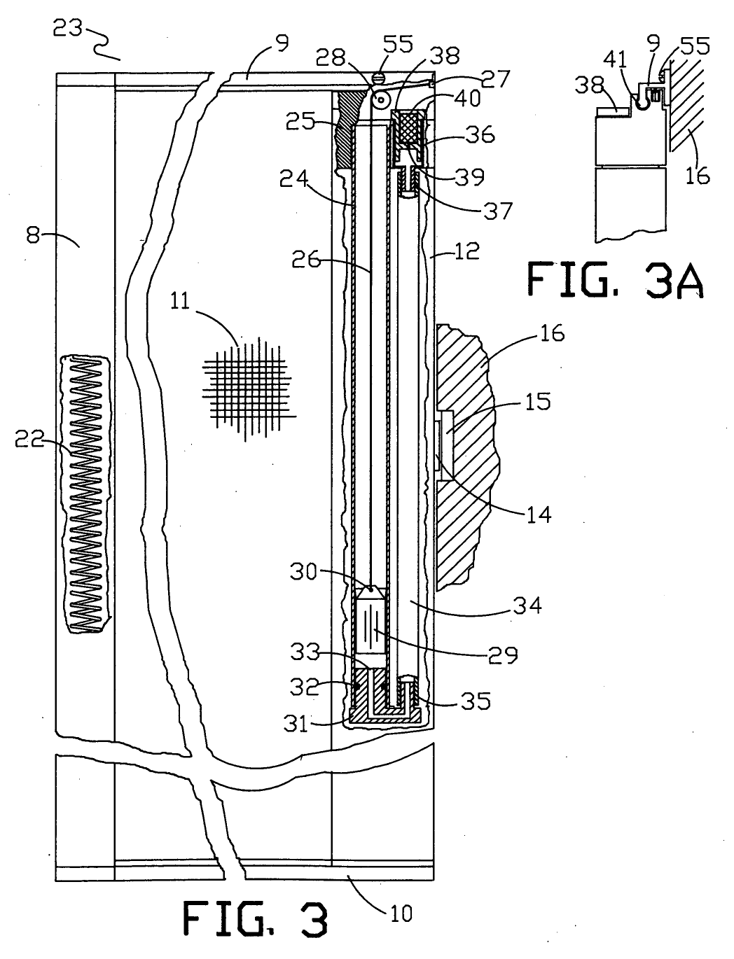

FIG. 3 shows a retractable screen door system 23 of the present invention having an enclosure 8 similar to that shown in FIG. 2 but without any velocity reduction assembly therein. Also shown is a cutaway view of spiral spring 22 that acts in the same manner as the spring 22 shown in FIG. 2, namely, to provide the rotational force necessary to spool screen material 11 when the screen door is moved to an open condition. Items 9 and 10 again represent the upper and lower tracks respectively in which the screen material 11 and the upper and lower portions of the moveable housing 12 slide.

The velocity reduction system of the present invention, which is located in the moveable housing 12, will now be described in detail. Tube 24 is physically attached within the upper end cap 25 and its top end is open to allow passage of cable 26. The top end of cable 26 is attached at point 27, which is part of the upper track 9 and thus fixed relative to the doorframe. The attachment of cable 26 at point 27 can be accomplished using a hook or other means known in the trade. Cable 26 passes over pulley 28 and is fastened to weight 29 at point 30 using a cable clamp or other means known in the trade. Weight 29 is moveable in an up and down direction within tube 24 and is shown as a solid element but, as will be shown later, contains a check valve apparatus. Adapter 31 fits into the bottom opening of tube 24 and is sealed against passage of air between it and the inner surface of tube 24 by O-ring 32. Opening 33 provides a path for air to pass from tube 24 to the flexible tubing 34. Tubing 34 is shown as a rigid structure but would typically be made from plastic or rubber material, allowing it to be slipped, onto adapter 31 at point 35 and onto holder 36 at point 37. The elasticity of the tubing 34 material holds the connections in place. Holder 36 is shown as a separate insert that is held in place in end cap 25, but could be molded as part of end cap 25. Metering insert 38 contains a metering hole 39 that will restrict the passage of air to the bottom end of tube 24 when the weight 29 moves upward. Thus the velocity with which the screen door opens can be changed by replacing the metering insert 38 with another insert with a metering hole 39 of a larger or smaller diameter. A larger metering hole 39 will result in a faster retraction speed. A filter element 40 prevents contaminants from blocking the metering hole 39. It should be understood that the placement of the metering insert 38 could be located at point 35 of adapter 31 without changing the performance of the velocity reduction system. The purpose in locating metering insert 38 as shown in FIG. 3 and coupled to the adapter 31 using tubing 34 is to provide a convenient location for changing the metering insert.

FIG. 3A is a front cutaway view of the top end cap to show the relative position of the metering insert 38 and the method of capturing the upper track 9 at point 41. It can be seen that upper track 9 is fastened to the doorframe 16 by screw 55.

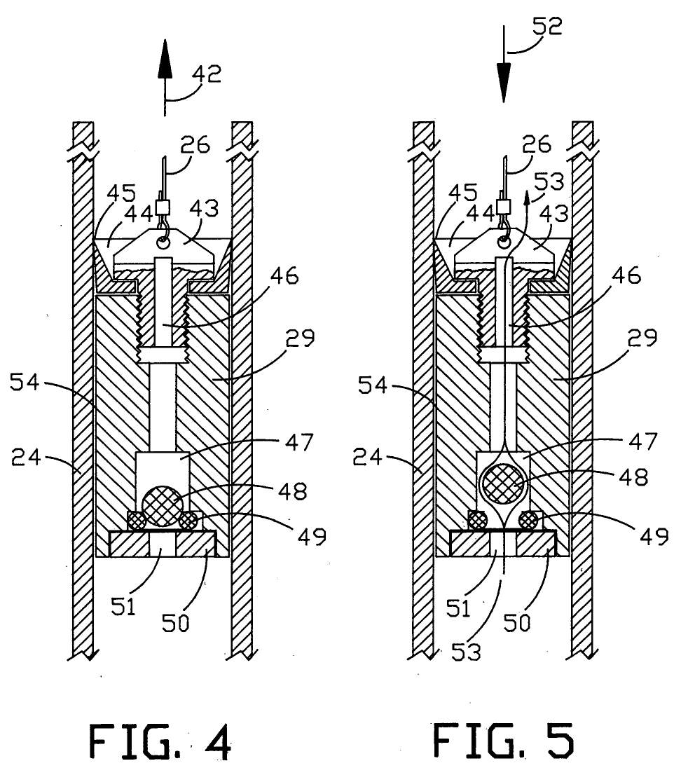

FIG. 4 is an enlarged, cross sectional view of the weight 29 which is suspended on cable 26 in a static condition or is being pulled upward by the cable 26 as indicated by arrow 42 when the screen door is being opened. It can be seen that in this condition sphere 48, which can be a steel ball bearing, rests on O-ring 49, thereby forming a blocking seal to any air that might attempt to pass from the top volume above weight 29 to the bottom volume below weight 29, through passages 46, 47 and 51. There is another path for airflow between the volumes above and below weight 29 and that is represented as gap 54 between the inner surface of tube 24 and the outer surface of weight 29. The amount of such air leakage can be minimized by closely controlling the dimensional clearance between tube 24 and weight 29. In addition, a provision has been made by including a wiper seal 44 that is held in place by screw 43. The wiper seal was selected to minimize the friction against the inside wall of tube 24 when the weight 29 is falling under the normal gravitational force. It can be seen that the wiper seal 44 makes contact with the inner wall of tube 24 at the circumference point 45, and will have an outward pressure against the inner wall of tube 24 as weight 29 is pulled upward, thus enhancing the sealing effect. It can now be seen, as previously mentioned in the description of FIG. 3, that the force that retards the movement of weight 29 and thus the retraction speed of the screen 11 is controlled by the pressure differential across weight 29. In addition, as previously described, the rate at which the screen 11 of FIG. 3 will retract into the enclosure 8 will be mainly controlled by the force exerted by spring 22 and the size of metering hole 39. Retaining ring 50 holds O-ring 49 in place.

FIG. 5 is also an enlarged cross sectional view of weight 29 showing the position of the check valve comprised of sphere 48 and O-ring 49 when the weight is falling under a gravitational force. This is the condition that would occur when an individual is closing the screen door, thereby allowing the weight 29 to pull downward on cable 26 in the direction shown by arrow 52. Because a higher air pressure now exists in the volume below the weight 29 relative to the volume above weight 29 the check valve sphere 48 is forced away from its seal with O-ring 49. This allows air to pass via the path shown by arrow 53 through the passages 51 and 47 around sphere 48 and through passage 46 in the center of screw 43. It can be seen that this provides very little restriction to airflow, and the weight 29 will fall at a rate determined by the speed at which the individual is closing the screen door.

It was mentioned earlier that this invention overcomes four basic deficiencies present in the prior art designs. Addressing each deficiency in order, it can be seen that this invention requires no frictional component such as the prior art centrifugal friction retarding mechanism. Secondly, this invention contains no viscous fluid, thereby eliminating the possibility of fluid leakage. Thirdly, since the velocity retarding mechanism is located in the moveable housing 12, there is no possibility of forcing the screen to open at a faster rate than the retraction spring 22 can spool the screen material 11. Lastly, this invention provides a means of adjusting the rate at which the screen will open if the individual opening the screen door releases the handle.

It can now be seen that this invention provides an improved velocity reduction system for retractable screen doors. While the above description has focused on retractable screen doors, it should be understood that it is equally applicable to retractable, screened windows that open and close in a similar manner. The description of this invention is illustrative and not limiting; further modifications will be apparent to one skilled in the art, in light of this disclosure and appended claims.

What is claimed is:

1. A velocity retarding system within a moveable housing of a retractable screen door installation that reduces the speed at which the screen door retracts to an open condition, the system comprising:
a movable housing having a shape allowing it to fit into a guidance track for the purpose of sliding back and forth in response to an opening and closing force necessary to open and close a screen door;
a screen attached to said moveable housing;
a tubular structure having an opening at the top and bottom and which is physically attached within said movable housing;
a weight housed and movable within said tubular structure;
a cable attached between said weight and a fixed point external to said tubular structure;
a check valve that will block the passage of air through said check valve when said weight is moving in an upward direction within said tubular structure, and will allow the passage of air through said check valve when said weight is moving in a downward direction within said tubular structure; and
a metering insert having a metering hole for the purpose of restricting the rate at which air can enter one end of said tubular structure.

2. A velocity retarding system as defined in claim 1 wherein: said check valve is an integral part of said weight.

3. A velocity retarding system as defined in claim 1 wherein: a sealing means is attached to the top of said weight.

4. A velocity retarding system as defined in claim 1 wherein: said cable is routed over a pulley.

5. A velocity retarding system as defined in claim 1 wherein: said metering insert is a separate, replaceable element.

6. A velocity retarding system as defined in claim 1 wherein: said metering insert contains an air filter.

7. A velocity retarding system as defined in claim 1 wherein: an adapter with an opening there through fits into said bottom opening of said tubular structure.

8. A velocity retarding system as defined in claim 1 wherein: said metering insert is located in a position to allow interchangeability of one metering insert having a metering hole of a specific size with a metering insert having a metering hole of a different size.

9. A velocity retarding system as defined in claim 1 wherein: said tubular structure, said weight, said check valve, said adapter, and said metering insert are combined as an assembly within said moveable housing to form an integral part of a total retractable screen door installation.

10. A velocity retarding system within a moveable housing of a retractable screen door installation that reduces the speed at which the screen door retracts to an open condition, the system comprising:
a movable housing having a shape allowing it to fit into a guidance track for the purpose of sliding back and forth in response to an opening and closing force necessary to open and close a screen door;
a screen attached to said moveable housing;
a tubular structure having an opening at the top and bottom and which is physically attached within said movable housing;
a weight housed and movable within said tubular structure;
a cable attached between said weight,and a fixed point external to said tubular structure;
a check valve that will block the passage of air through said check valve when said weight is moving in an upward direction within said tubular structure, and will allow the passage of air through said check valve when said weight is moving in a downward direction within said tubular structure;
an adapter attached to the bottom opening of said tubular structure;
a flexible tubing having an opening at the top and bottom; said bottom opening of said flexible tubing attached to said adapter; and
a metering insert attached to said top opening of said flexible tubing.
